(19) United States
(12) Patent Application Publication
(10) Pub. No.: US 2026/0268277 A1
(43) Pub. Date: Sep. 10, 2026

(54) INFORMATION PROCESSING APPARATUS

(71) Applicant: NEC Corporation, Tokyo (JP)

(72) Inventor: Masayoshi OHUCHI, Tokyo (JP)

(73) Assignee: NEC Corporation, Tokyo (JP)

(21) Appl. No.: 19/544,187

(22) Filed: Feb. 19, 2026

(30) Foreign Application Priority Data
Mar. 4, 2025 (JP) 2025-033629

(51) Int. Cl. G06Q 10/10; G06Q 10/0631

(52) U.S. Cl. CPC G06Q 10/10; G06Q 10/063114

(57) ABSTRACT

An information processing apparatus of the present disclosure includes an acquisition unit configured to acquire action information on a person detected from an image, and a writing unit configured to write information based on the action information acquired into a database, in which the writing unit controls whether to write the information based on the action information acquired into the database, based on the information based on the action information acquired and prediction information on an action based on the action information in the past.

### INCORPORATION OF BASIC APPLICATION

The present invention is based upon and claims the benefit of the priority of Japanese Patent Application No. 2025-033629 filed on Mar. 4, 2025 in Japan, the disclosure of which is incorporated herein in its entirety by reference.

### TECHNICAL FIELD

The present disclosure relates to an information processing apparatus.

### BACKGROUND ART

In a site where a person works, such as a factory or a warehouse, action of the person is converted into data. For example, PTL 1 describes that video data obtained by capturing an image of a work site is acquired and an action of a worker is analyzed.

PTL 1: JP 2021-501424 A

### SUMMARY

However, in the case of analyzing the action of the worker from the video data as described in PTL 1, there is a possibility that processing of writing action information in a database cannot be appropriately performed when an amount of data increases, for example, when the number of cameras increases.

For this reason, one of the objects of the present disclosure is to solve the problem described above, that is, there is a possibility that the processing of writing the action information in the database cannot be appropriately performed.

An information processing apparatus that is an aspect of the present disclosure has a configuration in which
the information processing apparatus includes
an acquisition unit configured to acquire action information on a person detected from an image, and
a writing unit configured to write information based on the action information acquired into a database, in which
the writing unit controls whether to write the information based on the action information acquired into the database, based on the information based on the action information acquired and prediction information on an action based on the action information in the past.

An information processing method that is an aspect of the present disclosure has a configuration in which
an information processing apparatus
acquires action information on a person detected from an image,
writes information based on the action information acquired into a database, and
further controls whether to write the information based on the action information acquired into the database, based on the information based on the action information acquired and prediction information on an action based on the action information in the past.

A program that is an aspect of the present disclosure has a configuration in which
the program causes
an information processing apparatus
to execute processing of
acquiring action information on a person detected from an image,
writing information based on the action information acquired into a database, and
further controlling whether to write the information based on the action information acquired into the database, based on the information based on the action information acquired and prediction information on an action based on the action information in the past.

With the above configuration, the present disclosure can appropriately perform processing of writing action information in a database.

### BRIEF DESCRIPTION OF THE DRAWINGS

FIG. 1 is a diagram illustrating an example of an overall configuration of an information processing system according to the present disclosure;

FIG. 2 is a block diagram illustrating an example of a configuration of the information processing system according to the present disclosure;

FIG. 3 is a flowchart illustrating an example of processing operation by the information processing system according to the present disclosure;

FIG. 4 is a flowchart illustrating the example of the processing operation by the information processing system according to the present disclosure;

FIG. 5 is a diagram illustrating an example of processing data by the information processing system according to the present disclosure;

FIG. 6 is a diagram illustrating an example of the processing data by the information processing system according to the present disclosure;

FIG. 7 is a diagram illustrating an example of the processing data by the information processing system according to the present disclosure;

FIG. 8 is a block diagram illustrating an example of a configuration of an information processing system according to the present disclosure;

FIG. 9 is a flowchart illustrating an example of processing operation by the information processing system according to the present disclosure;

FIG. 10 is a flowchart illustrating the example of the processing operation by the information processing system according to the present disclosure;

FIG. 11 is a diagram illustrating an example of the processing data by the information processing system according to the present disclosure;

FIG. 12 is a block diagram illustrating an example of a hardware configuration of an information processing apparatus according to the present disclosure;

FIG. 13 is a block diagram illustrating an example of a configuration of the information processing apparatus according to the present disclosure; and

FIG. 14 is a flowchart illustrating an example of processing operation by the information processing apparatus according to the present disclosure.

### EXAMPLE EMBODIMENT

### First Example Embodiment

A first example embodiment of the present disclosure will be described with reference to the drawings. The drawings may relate to any example embodiment.

As an example, an information processing system of the present disclosure is used to write action information on a person in a database at a site where the person works, such as a factory or a warehouse. More specifically, in the present example embodiment, control is performed so that a writing frequency of the action information on the person to the database is lowered, whereby it is enabled to appropriately write the action information to the database even in a case where an amount of data increases. Note that, in the present example embodiment, as an example, a description will be given of a case where a person performs actions, such as actions for shipping or arrival of an article, and inventory confirmation, and writes action information thereon in the database. However, information to be written in the database in the present disclosure is not limited to the action information with the content described above, and may be information with any action content in any place.

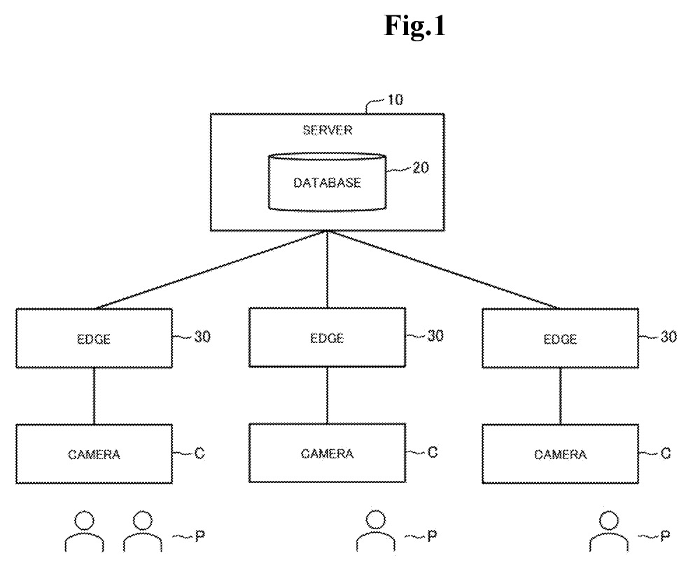

Hereinafter, a description will be given of an example of a configuration and operation of the information processing system in the present example embodiment. As illustrated in FIG. 1, the information processing system includes a plurality of cameras C that capture images of persons P working at a site such as a factory or a warehouse, edges 30 that analyze captured images captured by the cameras C, and a server 10 that writes action information on the persons analyzed from the captured images in a database 20. Hereinafter, each configuration will be described in detail.

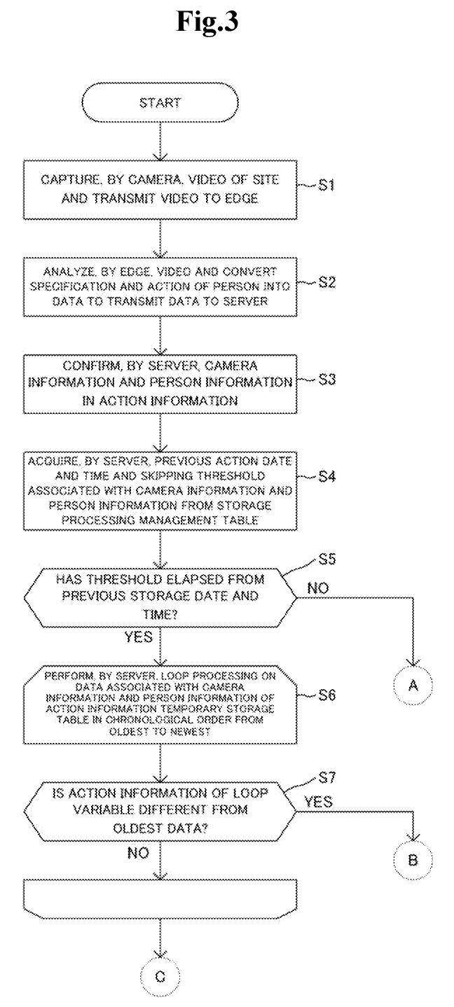

The plurality of cameras C is installed at predetermined locations in the site, and captures actions of the persons P working at the respective locations. For example, the camera C generates a captured image by capturing an image at 5 frames per second (fps) or 15 fps. Then, the camera C transmits a video that is the captured image to the edge 30 connected thereto (step S1 in FIG. 3).

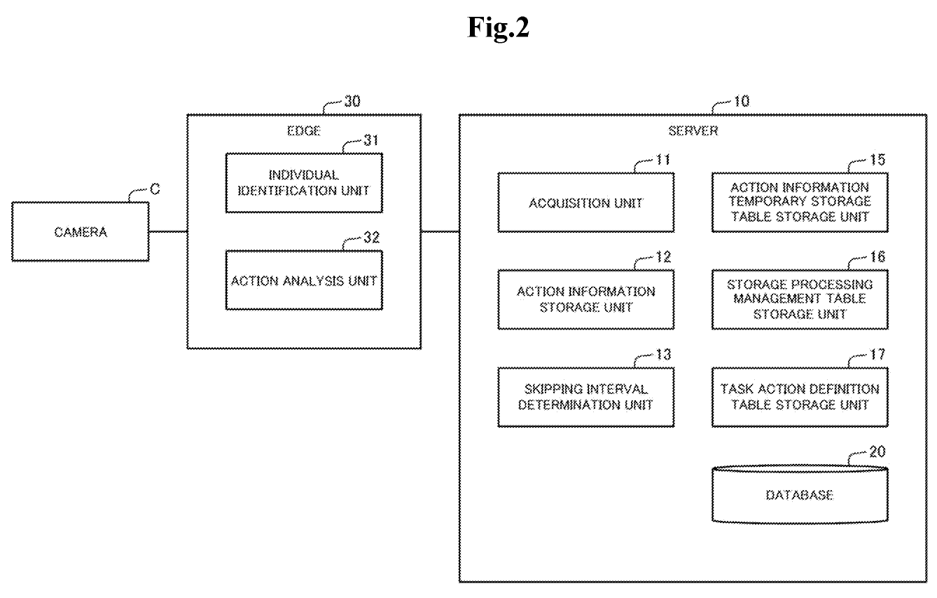

The edges 30 are prepared for the respective cameras C and connected thereto, and are each constituted by one or a plurality of information processing apparatuses each including an arithmetic device and a storage device. As illustrated in FIG. 2, the edge 30 includes an individual identification unit 31 and an action analysis unit 32. Functions of the individual identification unit 31 and the action analysis unit 32 can be implemented by the arithmetic device executing a program for implementing the functions stored in the storage device.

The individual identification unit 31 performs analysis processing on the captured image acquired from the camera C, identifies and specifies a person, and generates person information. The action analysis unit 32 performs analysis processing on the captured image, identifies an action of the person, and generates action information. At this time, the action information is, for example, information on actions such as inspection, picking, moving using cart, packing, and inspection, which are actions of shipping work of an article, information on actions such as inspection, moving using cart, and loading, which are actions of arrival work, and information on actions such as PC operation, which are actions of inventory confirmation work.

The individual identification unit 31 and the action analysis unit 32 transmit, to the server 10, the action information generated by analyzing the captured image in association with person information on a person who has performed an action thereof, camera information for specifying the camera C that has captured the captured image, and date and time information on capturing of the captured image (step S2 in FIG. 3).

The server 10 is constituted by one or a plurality of information processing apparatuses each including an arithmetic device and a storage device. As illustrated in FIG. 2, the server 10 includes an acquisition unit 11, an action information storage unit 12, and a skipping interval determination unit 13. Functions of the acquisition unit 11, the action information storage unit 12, and the skipping interval determination unit 13 can be implemented by the arithmetic device executing a program for implementing the functions stored in the storage device. In addition, the server 10 includes an action information temporary storage table storage unit 15, a storage processing management table storage unit 16, a task action definition table storage unit 17, and a database 20, which are implemented by the storage device. Note that the database 20 may be disposed outside the server 10 and connected to the server 10.

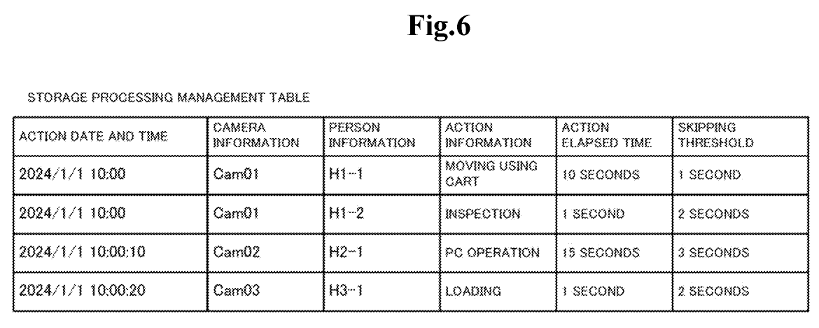

The acquisition unit 11 acquires the action information transmitted from the edge 30. Then, the action information storage unit 12 confirms the camera information and the person information associated with the action information (step S3 in FIG. 3). Further, the action information storage unit 12 acquires previous “action date and time” and “skipping threshold” (prediction information) associated with the camera information and the person information on the action information, from a storage processing management table stored in the storage processing management table storage unit 16 (step S4 in FIG. 3). In the storage processing management table, as illustrated in FIG. 6, the action date and time, the camera information, the person information, the action information, action elapsed time, and the skipping threshold are associated with each other. Details of the storage processing management table will be described later.

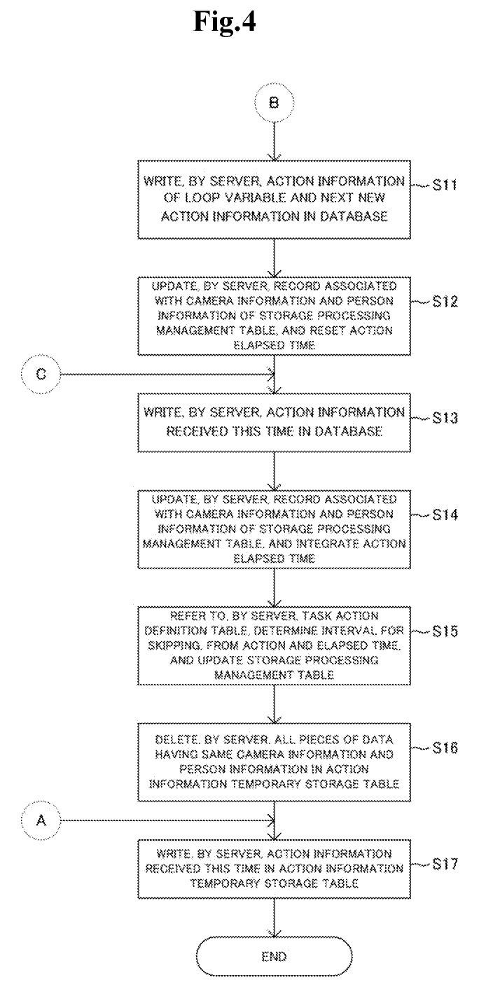

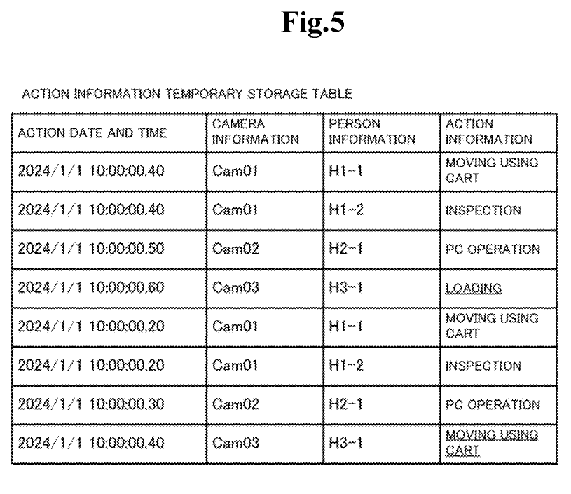

The action information storage unit 12 examines whether a time for an action relevant to the action information acquired this time has passed the skipping threshold from a time when previous action information is stored (step S5 in FIG. 3). For example, the action information storage unit 12 calculates a time from an action date and time of the previous action information to an action date and time of the action information acquired this time, and examines whether the time has passed the skipping threshold. Then, if the time for the action from the previous time to this time has not passed the skipping threshold (NO in step S5 in FIG. 3), the action information storage unit 12 stores the action information acquired this time in an action information temporary storage table of the action information temporary storage table storage unit 15 (step S17 in FIG. 4). Here, FIG. 5 illustrates an example of the action information temporary storage table. The action information temporary storage table stores the action date and time, the camera information, the person information, and the action information. In a case where the action information acquired this time is stored in the action information temporary storage table, the action information storage unit 12 does not write the action information in the database.

On the other hand, in a case where the time for the action of the action information acquired this time has passed the time of the skipping threshold from the time when the previous action information is stored (YES in step S5 in FIG. 3), the action information storage unit 12 performs loop processing on data of the action information temporary storage table associated with the camera information and the person information on the action information acquired this time in chronological order from oldest to newest (step S6 in FIG. 3). If the action information of a loop variable is different from the oldest data (YES in step S7 in FIG. 3), the action information storage unit 12 writes the action information of the loop variable and the next new action information in the database 20 (step S11 in FIG. 4). Then, the action information storage unit 12 updates a record associated with the camera information and the person information of the storage processing management table illustrated in FIG. 6, and resets the action elapsed time (step S12 in FIG. 4).

Thereafter, and in a case where the action information of the loop variable is not different from the oldest data in the loop processing and the loop processing ends (NO in step S7 in FIG. 3), the action information storage unit 12 writes the action information acquired this time in the database (step S13 in FIG. 4). As described above, in a case where action information is newly acquired, the action information storage unit 12 writes the new action information in the database 20 in a case where a time for an action of the new action information has passed the time of the skipping threshold set according to the action information in the past. On the other hand, in a case where the time for the action of the new action information has not passed the time of the skipping threshold, the new action information is not written to the database 20. As a result, by using the fact that most of the actions are predicted to be continuation of the previous actions thereof, the action information is written in the database 20 while being skipped at a frequency, for example, 1 fps, which is lower than a generation frequency of the action information from the captured image, such as 5 fps or 15 fps, for example.

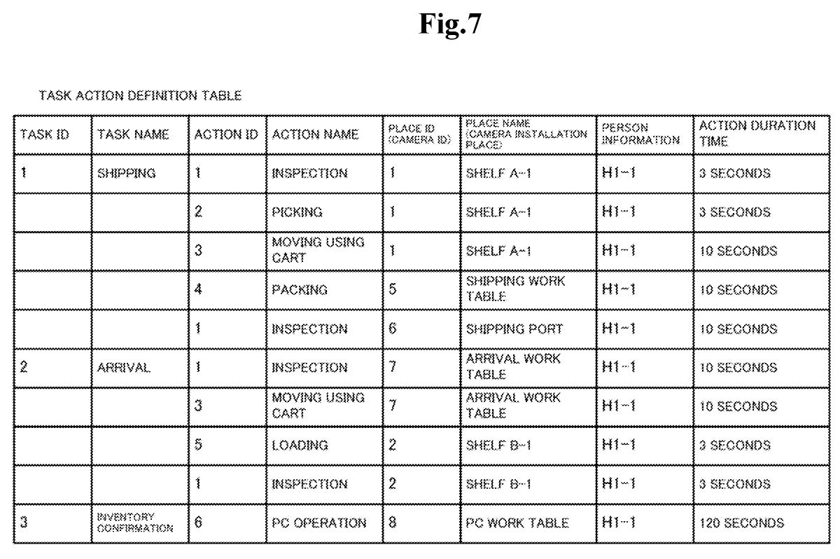

Thereafter, the skipping interval determination unit 13 updates the record of the storage processing management table associated with the camera information and the person information on the action information acquired this time, and integrates the action elapsed time. At this time, the skipping interval determination unit 13 integrates the action elapsed time, based on, for example, the action date and time recorded in the storage processing management table illustrated in FIG. 6 and the action date and time of the action information acquired this time (step S14 in FIG. 4). Further, the skipping interval determination unit 13 refers to a task action definition table stored in the task action definition table storage unit 17, determines an interval for skipping from the action information and an elapsed time, and updates the storage processing management table (step S15 in FIG. 4). Here, an example of the task action definition table is illustrated in FIG. 7. In the task action definition table, an action duration time is set for each action set for each task. For this reason, the skipping interval determination unit 13 calculates a time during which the same action is predicted to continue thereafter, based on the action elapsed time relevant to the current action information and the action duration time set in the task action definition table, and determines the calculated time as the skipping interval. As an example, the current action elapsed time is subtracted from the action duration time to determine the skipping interval.

Then, the action information storage unit 12 deletes all pieces of data having the same camera information and person information on the action information acquired this time from the action information temporary storage table (step S16 in FIG. 4). Then, the action information storage unit 12 stores the action information received this time in the action information temporary storage table (step S17 in FIG. 4).

As described above, in the present disclosure, the skipping interval during which the action information can continue is set according to the content of the action information, and writing to the database 20 is skipped in a case where the time for the action of the acquired action information has not passed the skipping interval. As a result, the frequency of writing data to the database 20 can be reduced, and write processing to the database 20 can be made efficient. As a result, processing of writing the action information in the database can be appropriately performed, and for example, the number of cameras that can be handled by the system can also be increased.

### Second Example Embodiment

Next, a second example embodiment of the present disclosure will be described with reference to the drawings. The drawings may relate to any example embodiment.

An information processing system in the present example embodiment has a configuration similar to that of the above-described first example embodiment. In addition, the information processing system includes the following configuration. Hereinafter, a configuration different from the above will be mainly described.

As illustrated in FIG. 1, the information processing system in the present example embodiment includes the cameras C, the edges 30, and a server 10, as described above.

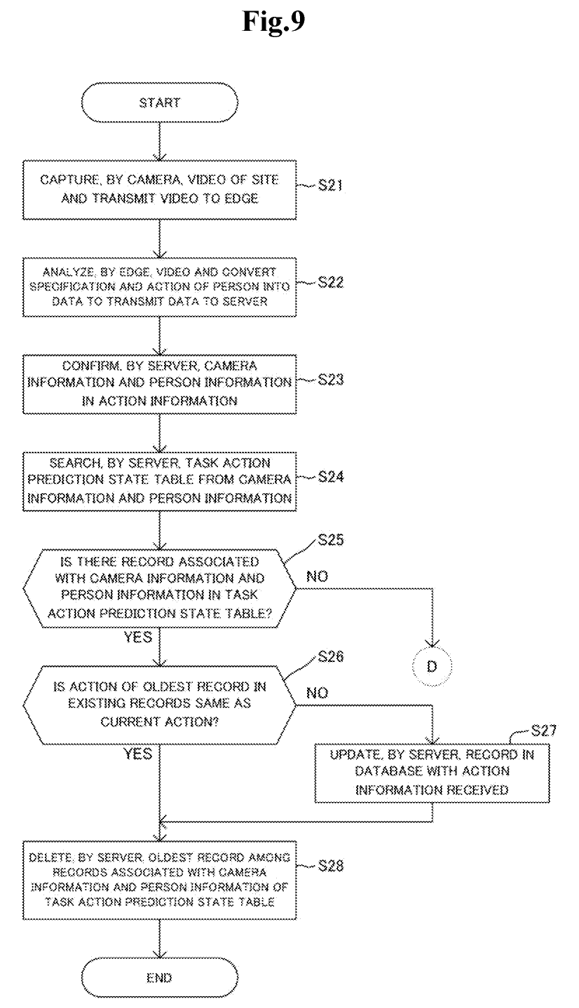

Similarly to the above, the camera C captures an image of an action of the person P who works, and transmits a video that is the captured image to the edge 30 connected thereto (step S21 in FIG. 9). Similarly to the above, the edge 30 analyzes the captured image, and transmits the action information, the person information, and the date and time information to the server 10 in association with each other (step S22 in FIG. 9).

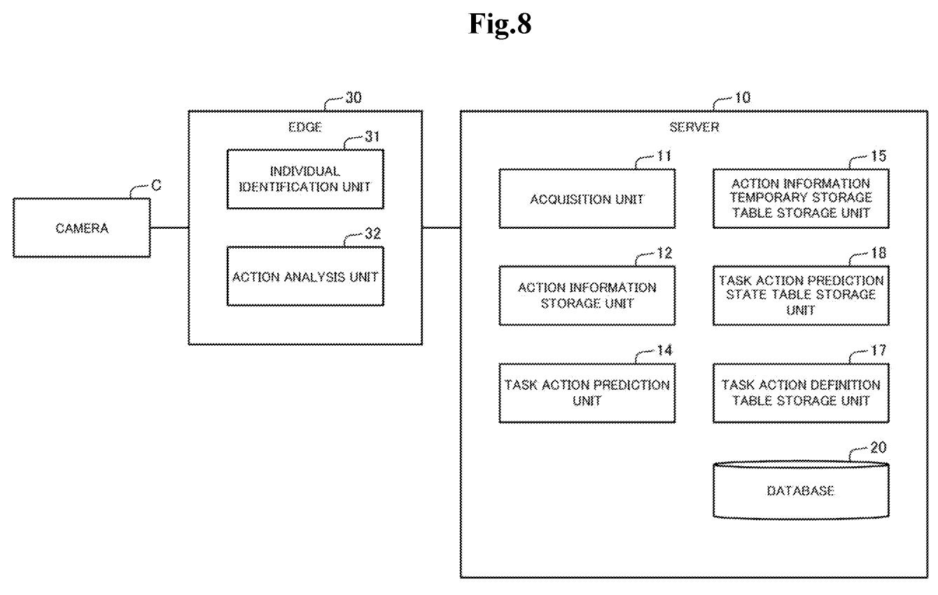

Then, as illustrated in FIG. 8, the server 10 of the information processing system in the present example embodiment includes the acquisition unit 11, the action information storage unit 12, and a task action prediction unit 14. Functions of the acquisition unit 11, the action information storage unit 12, and the task action prediction unit 14 can be implemented by the arithmetic device executing a program for implementing the functions stored in the storage device. In addition, the server 10 includes the action information temporary storage table storage unit 15, the task action definition table storage unit 17, a task action prediction state table storage unit 18, and the database 20, which are implemented by the storage device. Note that the database 20 may be disposed outside the server 10 and connected to the server 10.

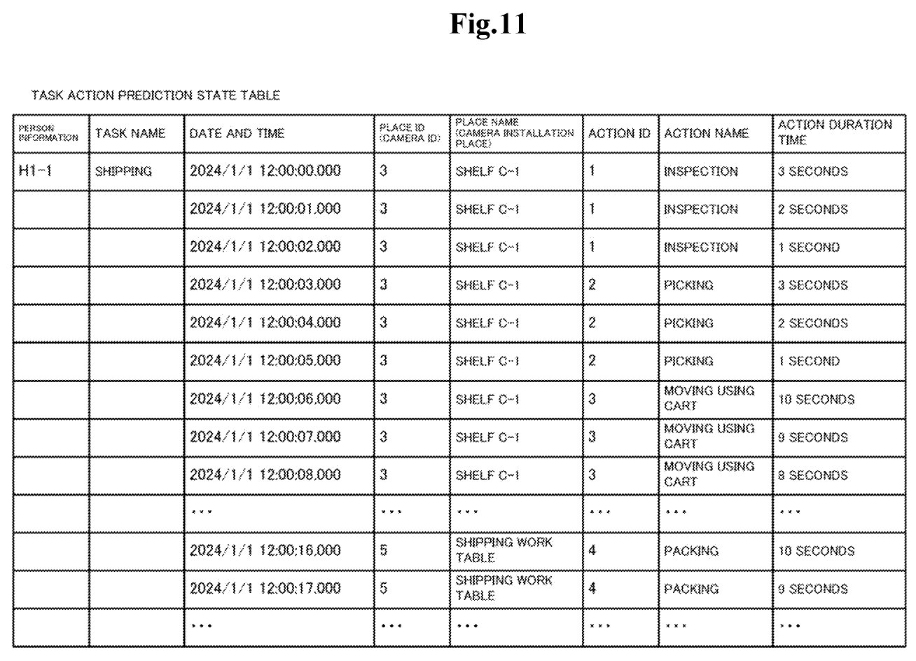

The acquisition unit 11 acquires the action information transmitted from the edge 30. The action information storage unit 12 confirms the camera information and the person information associated with the action information (step S23 in FIG. 9). Further, the action information storage unit 12 searches for data relevant to the camera information and the person information on the action information from a task action prediction state table (prediction information) stored in the task action prediction state table storage unit 18 (step S24 in FIG. 9). As illustrated in FIG. 11, the task action prediction state table includes records in which person information, a task name, date and time, a place ID (camera ID), a place name (camera installation place), an action ID, an action name, and an action duration time are associated with each other. As described later, the task action prediction state table is a series of pieces of action information in chronological order predicted relevant to a specific action, and has the same content as information written in the database 20, based on the action information in the past.

The action information storage unit 12 examines whether a record associated with the camera information and the person information on the action information acquired this time is in the task action prediction state table (step S25 in FIG. 9). In a case where the record relevant to the action information acquired this time is in the task action prediction state table (YES in step S25 in FIG. 9), and in a case where the action of the oldest record among the existing records is the same as the action of the action information acquired this time (YES in step S26 in FIG. 9), the action information storage unit 12 deletes the oldest record in the task action prediction state table (step S28 in FIG. 9). In this case, the action information storage unit 12 does not write the action information acquired this time in the database 20. On the other hand, in a case where the action of the oldest record among the existing records is not the same as the action of the action information acquired this time (NO in step S26 in FIG. 9), the action information storage unit 12 writes the action information acquired this time in the database 20 to update the record in the database 20 (step S27 in FIG. 9). Then, the action information storage unit 12 deletes the oldest record in the task action prediction state table (step S28 in FIG. 9).

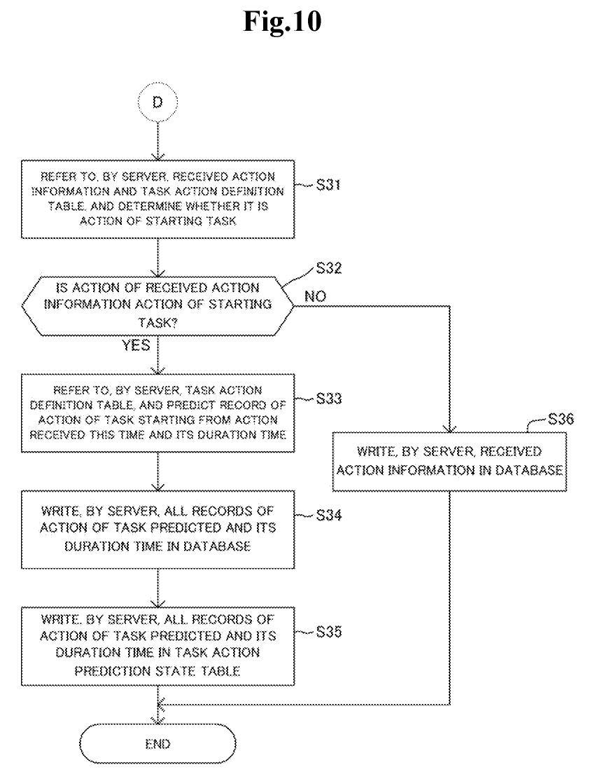

In a case where the record relevant to the action information acquired this time is not in the task action prediction state table (NO in step S25 in FIG. 9), the action information storage unit 12 refers to the task action definition table stored in the task action definition table storage unit 17 and determines whether the action of the action information acquired this time is an action of starting a task (step S31 in FIG. 10). In the task action definition table, as illustrated in FIG. 7, a series of actions set for each task is recorded in chronological order, and the action duration time of each action is further stored. For this reason, the action information storage unit 12 can examine whether the action of the action information acquired this time is the first action of any task in the task action definition table and determine whether the action is the first action of the task.

Then, in the action information storage unit 12, in a case where the action of the action information acquired this time is an action of starting a task (YES in step S32 in FIG. 10), the task action prediction unit 14 refers to the task action definition table and predicts a record of a series of actions starting from the action of the action information acquired this time and the duration time of each action (step S33 in FIG. 10). For example, the task action prediction unit 14 acquires a record of a series of pieces of action information included in the task starting from the action of the action information acquired this time. Then, the task action prediction unit 14 writes all records of the series of pieces of action information predicted and acquired into the database 20 (step S34 in FIG. 10). In addition, the task action prediction unit 14 writes all records of the series of pieces of action information written in the database 20 in the task action prediction state table (step S35 in FIG. 10). In a case where the action information acquired this time is not an action of starting a task (NO in step S32 in FIG. 10), the action information storage unit 12 writes the action information received this time in the database 20 (step S36 in FIG. 10).

As described above, in the present disclosure, in a case where the action information to be written is an action of starting a task, a series of pieces of action information on the task is collectively written in the database 20 and also written in the task action prediction state table. In a case where the action information acquired thereafter exists in the task action prediction state table and matches a prediction of action, the action information is not written in the database 20. For example, in a factory or a warehouse, when an action of a person changes depending on task content, the task content can be defined by a series of flows of a duration time and a change pattern of the action. That is, in a case where the first action of a certain task work is detected, it is possible to predict how long the action will continue, and what action will be taken next from when to when. Then, all the series of actions predicted in this way are written in the database 20 at a timing when the first action of the task is detected, and writing of the subsequent actions to the database 20 is stopped in a case where the prediction written in the database 20 is correct, so that the writing frequency to the database 20 thereafter can be reduced. Note that, at this time, it is conceivable that the duration time and change pattern of the action of the task work change depending on factors such as each person, each place, a time period, and an environmental situation. For this reason, in the task action definition table, the duration time and change pattern of the action may be defined in advance, or may be dynamically updated based on a measured value while the system is operated.

As a result, in the present disclosure, the frequency of writing data to the database 20 can be reduced, and the write processing to the database 20 can be made efficient. The action information can be written in the database 20 while being skipped at a frequency, for example, 1 fps, which is lower than a generation frequency of the action information from the captured image, such as 5 fps or 15 fps, for example. As a result, processing of writing the action information in the database can be appropriately performed, and for example, the number of cameras that can be handled by the system can also be increased. In addition, since the writing frequency to the database is reduced, it is possible to increase an amount of person’s action data that can be stored in the database.

### Third Example Embodiment

Next, a third example embodiment of the present disclosure will be described with reference to the drawings. The drawings may relate to any example embodiment.

The information processing system in the present disclosure can be used not only in a factory or a warehouse, but also for all scenes in which a video of a site is captured by a camera and an action of a person, an object, or a machine is converted into data. In the present example embodiment, for example, on the assumption of the following scene, it is possible to capture action of any target with a camera, convert the action into data, and accumulate the data. Note that specifying an individual person or object can be performed according to a scene, and for example, specification is also possible by face authentication, object fingerprint distinction, or a code such as a QR code.

Specifically, the present disclosure can be applied to a scene where each employee performs various types of work indoors in an area of a certain size in an industry type involving work of a person indoors, for example, in a food and drink industry, an accommodation industry, a hairdressing and beauty industry, a welfare industry such as nursing care, a retail industry, and an automobile maintenance industry. For example, it is applicable to write, in the database, each action of a cooking task by a person in the food and drink industry, each action of a room makeup task by a person in the accommodation industry, each action of a nursing care task by a person in the welfare industry, and each action of a maintenance task by a person in the automobile maintenance industry.

The present disclosure can be applied to a scene where each employee performs various types of work in an area of a certain size outdoors in an industry type involving work of a person outdoors, for example, a mining industry, a construction industry, and a railway industry. For example, it is applicable to write, in the database, each action of a construction task by a person in the construction industry.

The present disclosure can be applied to a scene where a movement or a flow of an object is a core of a task in an industry type involving movement of an article, for example, a transportation industry, a wholesale industry, or a retail industry. For example, it is applicable to write, in the database, each action such as movement or picking of an object associated with a shipping task in the transportation industry. The present disclosure can be applied to a scene where operation of a machine is a core of a task in an industry type involving operation of the machine, for example, a manufacturing industry in which automation by the machine is advanced, electric, gas, and water industries, and a printing industry. For example, it is applicable to write, in the database, each action of a manufacturing task by a robot in the manufacturing industry.

### Fourth Example Embodiment

Next, a fourth example embodiment of the present disclosure will be described with reference to the drawings. In the present example embodiment, an outline of the information processing apparatuses and the like described in the above-described example embodiments will be illustrated. The drawings may relate to any example embodiment.

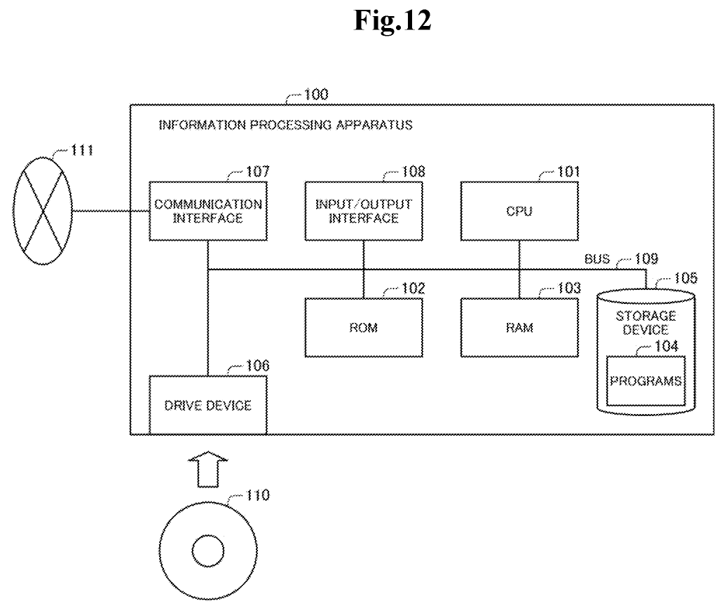

First, a hardware configuration of an information processing apparatus 100 in the present disclosure will be described. The information processing apparatus 100 is constituted by a general information processing apparatus, and is equipped with, as an example, the hardware configuration as follows, as illustrated in FIG. 12.

A Central Processing Unit (CPU) 101 (arithmetic device)

A Read Only Memory (ROM) 102 (storage device)

A Random Access Memory (RAM) 103 (storage device)

Programs 104 to be loaded into the RAM 103

A storage device 105 that stores the programs 104

A drive device 106 that performs reading and writing on a storage medium 110 outside the information processing apparatus

A communication interface 107 connected to a communication network 111 outside the information processing apparatus

An input/output interface 108 that inputs and outputs data

A bus 109 that connects each component

FIG. 12 illustrates an example of the hardware configuration of the information processing apparatus that is the information processing apparatus 100, and the hardware configuration of the information processing apparatus is not limited to the above case. For example, the information processing apparatus may be constituted by a part of the above configuration such as not including the drive device 106. The information processing apparatus can use, instead of the above-described CPU, a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, a combination of these, or the like.

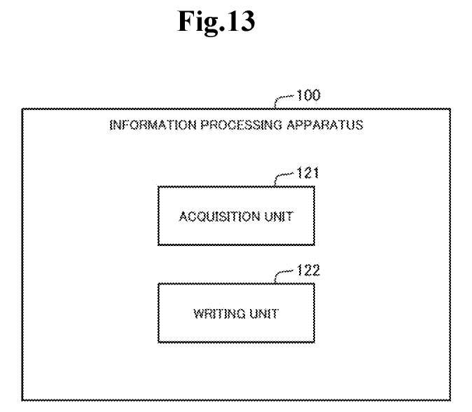

Then, an acquisition unit 121 and a writing unit 122 illustrated in FIG. 13 can be constructed and equipped in the information processing apparatus 100 by the CPU 101 acquiring the programs 104 and executing the acquired programs 104 by itself. The programs 104 are stored in, for example, the storage device 105 or the ROM 102 in advance, and the CPU 101 loads and executes the programs 104 on the RAM 103, as necessary. The programs 104 may be supplied to the CPU 101 via the communication network 111, or the programs 104 may be stored in the storage medium 110 in advance and the drive device 106 may read the programs 104 and supply the read programs 104 to the CPU 101. However, the acquisition unit 121 and the writing unit 122 described above may be constructed by a dedicated electronic circuit for implementing the means.

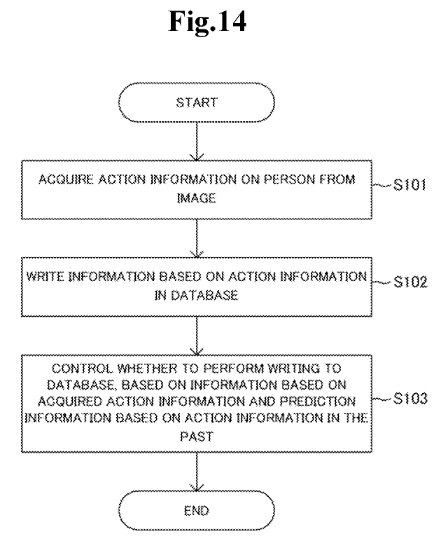

The acquisition unit 121 acquires action information on a person detected from an image (step S101 in FIG. 14). The writing unit 122 writes information based on the acquired action information in the database (step S102 in FIG. 14). Further, the writing unit 122 controls whether to write the information based on the acquired action information in the database, based on the information based on the acquired action information and prediction information on an action based on action information in the past (step S103 in FIG. 14).

In the above configuration, the information processing apparatus 100 writes the acquired action information in the database and sets the prediction information on an action thereof. Then, in a case where an action of action information acquired thereafter is an action predicted by the prediction information, it is possible to skip writing to the database. For example, a skipping interval of an action written in the database in the past is set as the prediction information, whereby the action is not written in the database in the case of the action within the skipping interval. For example, a series of actions written in the database in the past is set as the prediction information, whereby the action is not written in the database in a case where the action is included in the series of actions. By doing this, the writing frequency to the database can be made lower than an acquisition frequency of the action information. As a result, the write processing to the database can be made efficient, and the processing of writing the action information to the database can be appropriately performed.

At least one or more of the functions of the acquisition unit 121 and the writing unit 122 described above may be executed by an information processing apparatus installed and connected at any place on a network, that is, may be executed on so-called cloud computing.

The above-described programs can be stored using various types of non-transitory computer readable media and supplied to a computer. The non-transitory computer readable media include various types of tangible storage media. Examples of the non-transitory computer readable media include a magnetic recording medium (for example, a flexible disk, a magnetic tape, or a hard disk drive), an optical magnetic recording medium (for example, a magneto-optical disc), a Compact Disc-Read Only Memory (CD-ROM), a CD-R, a CD-R/W, and a semiconductor memory (for example, a mask ROM, a programmable ROM (PROM), an Erasable PROM (EPROM), a flash ROM, or a Random Access Memory (RAM)). The programs may also be supplied to the computer by various types of transitory computer readable media. Examples of the transitory computer readable media include electrical signals, optical signals, and electromagnetic waves. The transitory computer readable media can supply the programs to the computer via a wired communication path such as an electric wire and an optical fiber or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

### Supplementary Note

Some or all of the above example embodiments may also be described as in the following supplementary notes. Hereinafter, an outline of configurations of the information processing apparatus, the information processing method, and the program in the present disclosure will be described. However, the present disclosure is not limited to the configurations described in the following supplementary notes.

Some or all of the configurations described in supplementary notes 2 to 8.1 dependent on supplementary note 1 described below and the functions according to those configurations can also be dependent on other supplementary notes 9 and 10 by a dependency relationship similar to that of supplementary notes 2 to 8.1. Moreover, some or all of the configurations described as the supplementary notes and the functions according to those configurations can be similarly dependent on not only supplementary notes 1, 9, and 10, but also various pieces of similar hardware and software, and various types of recording means that record the software, or systems without departing from the above-described example embodiments.

### Supplementary note 1

An information processing apparatus including:

an acquisition unit configured to acquire action information on a person detected from an image; and

a writing unit configured to write information based on the action information acquired into a database, in which

the writing unit controls whether to write the information based on the action information acquired into the database, based on the information based on the action information acquired and prediction information on an action based on the action information in the past.

### Supplementary note 2

The information processing apparatus according to supplementary note 1, in which
the writing unit performs control so as to make a writing frequency to the database lower than an acquisition frequency of the action information, based on the information based on the action information acquired and the prediction information.

### Supplementary note 3

The information processing apparatus according to supplementary note 1, in which

the writing unit writes the information based on the action information in the database, sets information based on a predicted time of an action relevant to the action information as the prediction information, and controls whether to write the information based on the action information acquired into the database, based on a time for the action relevant to the action information acquired thereafter and the prediction information.

### Supplementary note 4

The information processing apparatus according to supplementary note 3, in which

the writing unit performs control, in a case where a time for the action relevant to the action information acquired, the time being based on a time of the action information acquired and a time of the action information in the past, has not passed a time set as the prediction information, so as not to write the information based on the action information in the database.

### Supplementary note 5

The information processing apparatus according to supplementary note 3, in which
the writing unit sets, based on a duration time of the action set in advance according to action content of the action information, information based on a predicted time of the action relevant to the action information acquired, as the prediction information.

### Supplementary note 5.1

The information processing apparatus according to supplementary note 5, in which
the writing unit calculates, based on the time for the action relevant to the action information acquired and the duration time of the action set in advance, the information based on the predicted time of the action relevant to the action information acquired, and sets the information as the prediction information.

### Supplementary note 6

The information processing apparatus according to supplementary note 1, in which
the writing unit writes a series of pieces of action information relevant to action content of the action information acquired into the database, sets the series of pieces of action information as the prediction information, and controls whether to write the information based on the action information in the database depending on whether the action information acquired thereafter is included in the prediction information.

### Supplementary note 7

The information processing apparatus according to supplementary note 6, in which
the writing unit performs control so as to write, in a case where the action information acquired is not included in the prediction information, the information based on the action information in the database, and so as not to write the information in the database in a case where the action information is included in the prediction information.

### Supplementary note 8

The information processing apparatus according to supplementary note 7, in which
the writing unit writes the series of pieces of action information in chronological order relevant to the action content of the action information acquired into the database, sets the series of pieces of action information as the prediction information, and deletes, in a case where the action information acquired thereafter is included in the prediction information, the action information in the prediction information in chronological order.

### Supplementary note 8.1

The information processing apparatus according to supplementary note 8, in which
the writing unit writes, in a case where an action of the action information is an action of starting a task set in advance, the series of pieces of action information in chronological order relevant to the action information, in the database.

### Supplementary note 9

An information processing method including:
by an information processing apparatus,
acquiring action information on a person detected from an image;
writing information based on the action information acquired into a database; and
further controlling whether to write the information based on the action information acquired into the database, based on the information based on the action information acquired and prediction information on an action based on the action information in the past.

### Supplementary note 9.1

The information processing method according to supplementary note 9, further including:
by the information processing apparatus,
writing the information based on the action information in the database, setting information based on a predicted time of an action relevant to the action information as the prediction information, and controlling whether to write the information based on the action information acquired into the database, based on a time for the action relevant to the action information acquired thereafter and the prediction information.

### Supplementary note 9.2

The information processing method according to supplementary note 9, further including:
by the information processing apparatus,
writing a series of pieces of action information relevant to action content of the action information acquired into the database, setting the series of pieces of action information as the prediction information, and controlling whether to write the information based on the action information in the database depending on whether the action information acquired thereafter is included in the prediction information.

### Supplementary note 10

A program for causing an information processing apparatus to execute processing of:
acquiring action information on a person detected from an image;
writing information based on the action information acquired into a database; and
further controlling whether to write the information based on the action information acquired into the database, based on the information based on the action information acquired and prediction information on an action based on the action information in the past.

### REFERENCE SIGNS LIST

10 server

11 acquisition unit

12 action information storage unit

13 skipping interval determination unit

14 task action prediction unit

15 action information temporary storage table storage unit

16 storage processing management table storage unit

17 task action definition table storage unit

18 task action prediction state table storage unit

20 database

30 edge

31 individual identification unit

32 action analysis unit

C camera

100 information processing apparatus

101 CPU

102 ROM

103 RAM

104 programs

105 storage device

106 drive device

107 communication interface

108 input/output interface

109 bus

110 storage medium

111 communication network

121 acquisition unit

122 writing unit

1. An information processing apparatus comprising:
at least one memory configured to store processing instructions; and
at least one processor configured to execute the processing instructions to:
acquire action information on a person detected from an image;
write information based on the action information acquired into a database; and
further control whether to write the information based on the action information acquired into the database, based on the information based on the action information acquired and prediction information on an action based on the action information in the past.

2. The information processing apparatus according to claim 1, wherein the at least one processor is configured to execute the processing instructions to
perform control in such a way as to make a writing frequency to the database lower than an acquisition frequency of the action information, based on the information based on the action information acquired and the prediction information.

3. The information processing apparatus according to claim 1, wherein the at least one processor is configured to execute the processing instructions to
write the information based on the action information in the database, set information based on a predicted time of an action relevant to the action information as the prediction information, and control whether to write the information based on the action information acquired into the database, based on a time for the action relevant to the action information acquired thereafter and the prediction information.

4. The information processing apparatus according to claim 3, wherein the at least one processor is configured to execute the processing instructions to
perform control, in a case where a time for the action relevant to the action information acquired, the time being based on a time of the action information acquired and a time of the action information in the past, has not passed a time set as the prediction information, in such a way so as not to write the information based on the action information in the database.

5. The information processing apparatus according to claim 3, wherein the at least one processor is configured to execute the processing instructions to
set, based on a duration time of the action set in advance according to action content of the action information, information based on a predicted time of the action relevant to the action information acquired, as the prediction information.

6. The information processing apparatus according to claim 1, wherein the at least one processor is configured to execute the processing instructions to
write a series of pieces of action information relevant to action content of the action information acquired into the database, set the series of pieces of action information as the prediction information, and control whether to write the information based on the action information in the database depending on whether the action information acquired thereafter is included in the prediction information.

7. The information processing apparatus according to claim 6, wherein the at least one processor is configured to execute the processing instructions to
perform control in such a way as to write, in a case where the action information acquired is not included in the prediction information, the information based on the action information in the database, and in such a way as not to write the information in the database in a case where the action information is included in the prediction information.

8. The information processing apparatus according to claim 7, wherein the at least one processor is configured to execute the processing instructions to
write the series of pieces of action information in chronological order relevant to the action content of the action information acquired into the database, set the series of pieces of action information as the prediction information, and delete, in a case where the action information acquired thereafter is included in the prediction information, the action information in the prediction information in chronological order.

9. The information processing apparatus according to claim 5, wherein the at least one processor is configured to execute the processing instructions to
calculate, based on the time for the action relevant to the action information acquired and the duration time of the action set in advance, the information based on the predicted time of the action relevant to the action information acquired, and set the information as the prediction information.

10. The information processing apparatus according to claim 8, wherein the at least one processor is configured to execute the processing instructions to
write, in a case where an action of the action information is an action of starting a task set in advance, the series of pieces of action information in chronological order relevant to the action information, in the database.

11. An information processing method comprising:
by an information processing apparatus,
acquiring action information on a person detected from an image;
writing information based on the action information acquired into a database; and
further controlling whether to write the information based on the action information acquired into the database, based on the information based on the action information acquired and prediction information on an action based on the action information in the past.

12. The information processing method according to claim 11, further comprising:
by the information processing apparatus,
writing the information based on the action information in the database, setting information based on a predicted time of an action relevant to the action information as the prediction information, and controlling whether to write the information based on the action information acquired into the database, based on a time for the action relevant to the action information acquired thereafter and the prediction information.

13. The information processing method according to claim 11, further comprising:
by the information processing apparatus,
writing a series of pieces of action information relevant to action content of the action information acquired into the database, setting the series of pieces of action information as the prediction information, and controlling whether to write the information based on the action information in the database depending on whether the action information acquired thereafter is included in the prediction information.

14. A non-transitory computer-readable storage medium storing a program for causing an information processing apparatus to execute processing of:
acquiring action information on a person detected from an image;
writing information based on the action information acquired into a database; and
further controlling whether to write the information based on the action information acquired into the database, based on the information based on the action information acquired and prediction information on an action based on the action information in the past.
